(19) United States
(12) Patent Application Publication
(10) Pub. No.: US 2009/0157500 A1
(43) Pub. Date: Jun. 18, 2009

(54) ADVANCED ADVERTISEMENTS

(75) Inventors: Robert Christopher Ames, Irving, TX (US); Christopher Jaffe, San Mateo, CA (US); Roderick E. Perkins, Menlo Park, CA (US); Abel Ignacio Rios, JR., McKinney, TX (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/957,425

(22) Filed: Dec. 15, 2007

(51) Int. Cl. G06Q 30/00; G06F 3/048

(52) U.S. Cl. 705/14; 715/764; 715/700

(57) ABSTRACT

A system and method for configuring a media player to display advertising to a user includes a computer having a processor and a memory unit containing instructions, a display in communication with the processor of the computer for displaying a media asset via the media player, and a network interface in communication with the processor. The instructions configure the processor to suspend the displaying of a media asset by the media player during certain periods and display a pre roll advertisement or a rich media advertisement in at least a portion of the display utilized by the media player.

### BACKGROUND OF THE INVENTION

1. Field of the Invention

The invention relates to Internet based advertising and more specifically to Internet based advertising used in concert with Internet based media.

2. Description of the Known Technology

Networked electronic devices, such as personal computers, mobile phones, personal digital assistants, game consoles, interactive television or automotive telematic devices, increasingly have the ability to display rich media, such as video and audio clips and even interactive games. In the past, advertising necessary to provide economic return to support the development of this rich media has been restricted to graphical advertisements such as banner advertisements or text based advertisements, either of which is placed somewhere in a web page containing the rich media.

One drawback to this form of advertising is that the rich media is often detachable from the web page from where it originates and can appear in any of the number of different contexts. For example, rich media, such as a video found on an online service provider such as Yahoo! Inc. of Sunnyvale, Calif., can be placed on web pages that are not hosted or searched by Yahoo! To be more specific, a video clip originally found on Yahoo! may be embedded using HTML code into a third party's personal web page. Therefore, given the mobility and variety of context sequential media appears in, an advertisement simply appearing in the page where the media first originated does not provide the necessary revenue and customer service opportunities needed to support the sequential media's hosting and distribution costs.

Other solutions to this problem have included the use of post-roll, mid-roll and pre-roll advertising that is attached to the sequential media. Pre-roll advertisements are advertisements that are displayed to the user before the selected sequential media begins playing. Post-roll advertisements are displayed to the user after the sequential media has finished playing. Post-roll advertising suffers from the fact that once the sequential media has concluded playing, the user has little incentive to continue watching or listening to the post roll advertisement.

Mid-roll advertisements are advertisements that are played in the middle of the sequential media. Timing of these mid-roll advertisements may be selected by either an algorithm or a human being. Mid-roll advertisements suffer from the fact that they may be awkward or may damage the users experience through unwanted interruption at a dramatic or informational high point. Additionally, the information the user sought from viewing the sequential media may have already been provided to the user, before the mid-roll advertisement is presented thus allowing the user to stop viewing the sequential media before the mid roll advertisement has been displayed.

Therefore, there is a need for an improved system and method for providing advertising information to a user viewing rich media.

### BRIEF SUMMARY OF THE INVENTION

In overcoming the drawbacks of the prior art, a system and method for configuring a media player to display advertising to a user includes a computer having a processor and a memory unit containing instructions, a display in communication with the processor of the computer for displaying a media asset via the media player, and a network interface in communication with the processor.

The instructions configure the processor to suspend the displaying of the media asset by the media player during an “alone time” and display a pre roll advertisement in the display utilized by the media player during the “alone time.” Thereafter, the instructions configure the processor to display the media asset after the alone time has expired.

The displaying of the media asset may further be suspended when prompted by a first action, such as the pausing of the media asset by the user. If this occurs, a rich media advertisement will be displayed in at least a portion of the display utilized by the media player. The displaying of the media asset will then resume when prompted by a second action, such as the unpausing of the media asset. Finally, once the media asset has finished playing. a second rich media advertisement will be displayed in at least a portion of the display utilized by the media player.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a block diagram of a system for providing advertising and network services to a user viewing Internet based media;

FIG. 2 is a block diagram of a general purpose computer shown in FIG. 1;

FIG. 3 is a screen capture of a media player displaying a pre-roll advertisement;

FIG. 4 is a screen capture of the media player of FIG. 3 displaying media and a persistent banner advertisement;

FIG. 5 is a screen capture of the media player of FIG. 3 displaying a rich media advertisement; and

FIG. 6 illustrates a flow chart of a method for configuring a media player to display advertising to a user.

### DETAILED DESCRIPTION OF THE INVENTION

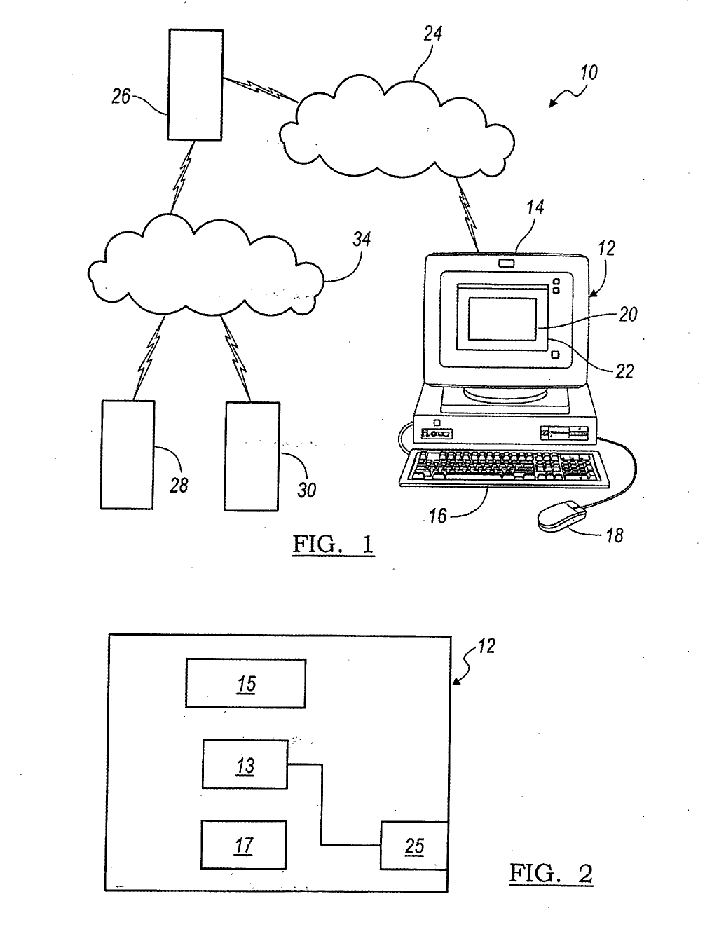

Referring to FIG. 1, a system 10 for providing advertising to a user viewing a media asset is shown. Generally, the media asset is sequential media, however, the media asset may be any type of Internet based media asset, such as an interactive computer game, a still picture, a micro website capable of launching other websites, an interactive map, an Internet telephony connection or an instant messaging connection. For this exemplary embodiment, the media asset will be sequential media. Sequential media includes visual, audible and other information presented in a sequence of discrete portions or a continuous stream of information, or a combination of these. The sequential media may be encoded as digital data or analog signals for processing, playback, storage or other use using appropriate hardware or software tools.

The system 10 includes a general purpose computer 12 having a display 14 and input devices such as a keyboard 16 and a mouse 18. The general purpose computer 12 is capable of displaying via the display 14 sequential media played by a media player 20. The media player 20 may be located within a window 22 of an Internet browser. However, it should be understood that the media player 20 may be located anywhere such that the display 14 can display the media player 20 to the user of the general purpose computer 12. Additionally, it should be understood that the media player 20 shown in the Figures is an example; any type of media player that can display media the display 14 of the general purpose computer can be utilized.

Referring to FIG. 2, a more detailed view of the general purpose computer 12 is shown. The general purpose computer 12 may be any one of a number of different devices capable of interfacing with the network 24. For example, the general purpose computer 12 may be a mobile device, such as a mobile phone or a personal digital assistant, a personal computer, or may be an Internet protocol television. Regardless of which form the general purpose computer takes, the general purpose computer 12 includes a processor 13 in communication with a memory unit 15. The memory unit 15 contains a set of instructions for configuring the processor to execute certain functions. A more detailed explanation of these functions will be described later in this section. The general purpose computer 12 may also include a storage device 17. The processor 13 of the general purpose computer 12 is connected to a network 24 (shown in FIG. 1) via a network interface. The network 24 is preferably a distributed network such as the Internet.

Referring back to FIG. 1, in order for the media player 20 to display the sequential media, a media object containing a media asset (which contains the sequential media) must be provided to the general purpose computer 12. This can be accomplished any one of a number of ways. For this example, a central server 26 can accomplish this task by transmitting a media object to the general purpose computer 12 via the network 24. As will be better described later, the media object contains not only the media asset but also contains an advertising asset, containing advertising information as well as executable code for controlling the media player.

Before the media object is sent to the general purpose computer 12, the central server 26 must first construct the media object to include the media asset as well as any advertising asset. The central server 26 accomplishes this task by requesting the media asset and the advertising asset from a sequential media server 28 and an advertisement server 30, respectfully, via a network 34. Similar to the network 24, the network 34 is generally a distributed network such as the Internet. However, it should be understood that the network 34 may be a local or wide area network.

When constructing the media object, the server 26 will request the appropriate sequential media asset from the media server 28. At around the same time, the central server 26 also requests the appropriate advertising asset from the advertising server 30. It should be understood that the central server 26 may select the appropriate advertising asset based upon a variety of algorithms. For example, the central server 26 may construct the profile of the user of the general purpose computer 12 such that the requested advertising asset is more likely to be of interest to the user of the general purpose computer 12. This may be accomplished by generating a central profile of the user of the general purpose computer 12. The central profile may be constructed by tracking the user's interaction with the general purpose computer 12 or by collecting information stored within the general purpose computer 12.

After the media asset as well as the advertising asset is provided to the central server 26, the central server 26 will then create the media object encapsulating both the media asset and the advertising asset within the media object. Alternatively, the media asset and the advertising asset may be sent directly to the general purpose computer 12 from the servers 28 and 30.

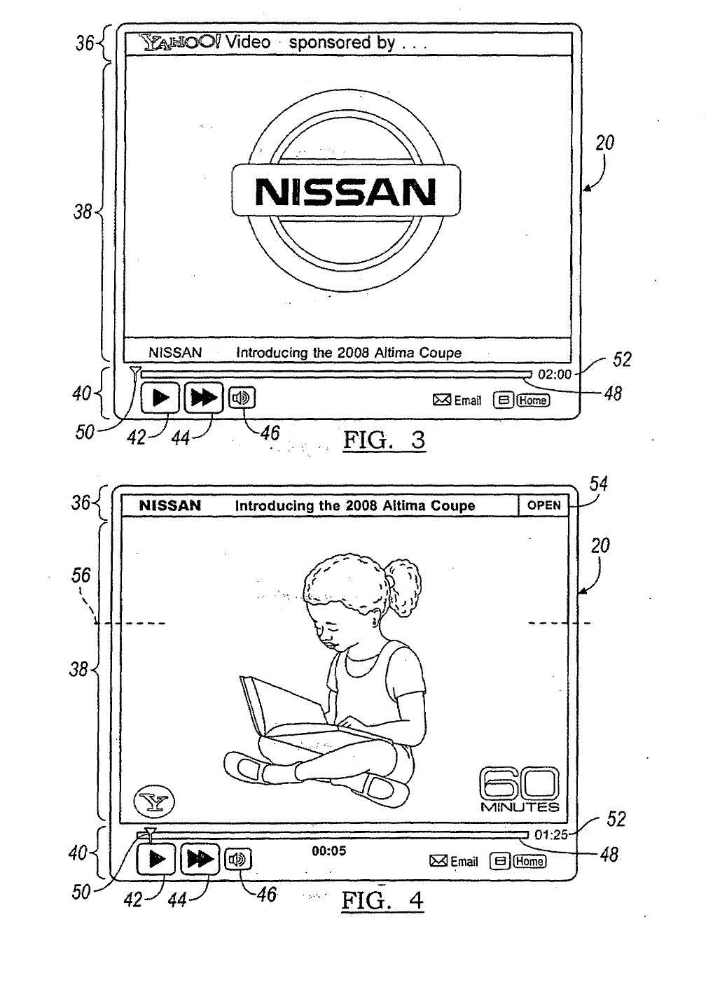

Referring to FIGS. 3 and 4, the portion of the display 14 being used by the media player 20 can be divided into three areas: a persistent banner 36, a sequential media area 38 and a control area 40. The persistent banner 36 in this exemplary embodiment is generally located at or near the top of the viewing area of the sequential media player 20. As best shown in FIG. 4, the persistent banner 36 contains advertising originating from the advertising asset provided by the advertising server 30.

The sequential media area 38 is a portion of the media player 20 used to display the sequential media asset. As stated before, although this embodiment shows the media player 20 displaying sequential media, any type of Internet based media asset may be displayed. Located below the sequential media area 38, in this embodiment, is the control area 40. The control area 40 includes a variety of controls for controlling the sequential media in the sequential media display area 38. The controls include a play button 42 for playing the sequential media, a fast forward button 44 for fast forwarding the sequential media, and a sound button 46 for adjusting the sound (if any) of the sequential media.

Additionally, the control area may include a progress bar 48 having a progress indicator 50 for graphically indicating the amount of play time left for the sequential media. A timer 52 can be displayed indicating the amount of time the sequential media has played or amount of playing time remaining. Of course, additional controls and indicators may be implemented within the control area 40 to provide the user additional ways to interact with the sequential media.

When the general purpose computer 12 receives the media object containing the sequential media asset and advertising asset from the central server 26, the media player 20 will first display a pre-roll advertisement as shown in FIG. 3. Like the persistent banner 36, the pre-roll advertisement originated from the advertising asset provided by the advertising server 30. The pre-roll advertisement is typically a short advertisement lasting less than about five seconds, but may be longer in duration. The pre-roll advertisement may be configured such that if the user clicks on the pre-roll advertisement, a website relating to the subject matter of the pre-roll advertisement may be launched. For example, the user may use a mouse or other pointing device attached to a computer displaying the media object to select or click on the pre-roll advertisement. In response, a web browser program is launched by the computer and directed to a website designated by the pre-roll advertisement.

The purpose of the pre-roll advertisement is to notify the user of the advertising sponsor without annoying the user such that the user decides not to view the sequential media. Furthermore, in order to further reduce the user's anxiety in waiting for the pre-roll advertisement to finish, a timer may be displayed to inform the user of the remaining duration of the pre-roll advertisement.

Referring now to FIG. 4, once the pre-roll advertisement has finished playing, the sequential media asset is displayed in the sequential media area 38. The persistent banner advertisement 36 is located above the sequential media area 38 and advertises products and services offer by the advertiser first displayed in the pre-roll advertisement. However, it should be understood that the persistent banner advertisement may be from a different advertiser than that of the pre-roll advertisement.

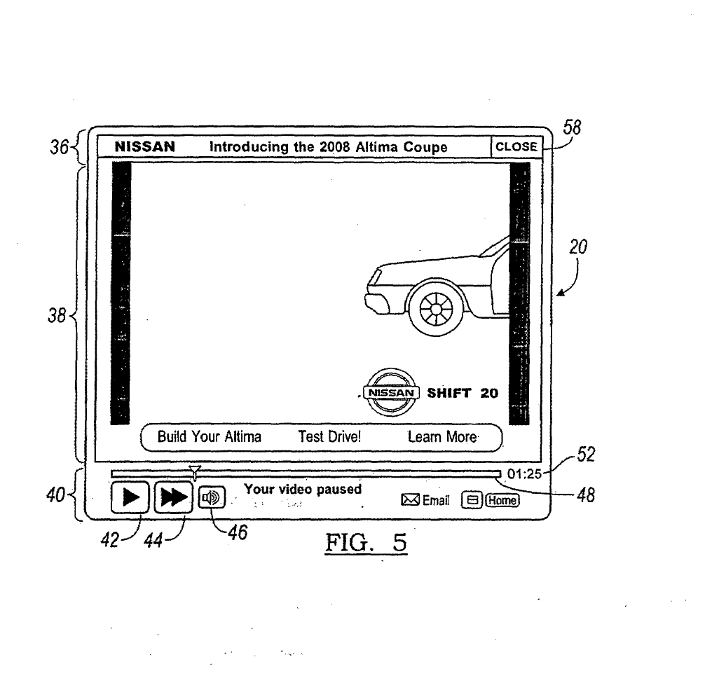

As the sequential media plays within the sequential area 38, the user 12 can then open a rich media advertisement shown in FIG. 5. Like the persistent banner 36 and pre-roll advertisement, the rich media advertisement originated from the advertising asset provided by the advertising server 30. The rich media advertisement of FIG. 5 can be opened in a variety of ways. The rich media advertisement may be opened by clicking the open button 54 shown in FIG. 4. Alternatively, the rich media advertisement may be opened by moving a cursor with the mouse 18 within an area located within the sequential media area 38. For example, this area may be the top one third of the sequential media area 38 as designated by line 56. An indicator (not shown) may be utilized by the media player 20 to encourage the user to open the rich media advertisement.

The rich media advertisement is displayed in at least a portion of the sequential media display area 38. The rich media advertisement may be a video, an interactive computer game, a configurator for building, pricing and buying goods and/or services, a static advertisement, a micro web site capable of launching other web sites, an interactive map, an Internet telephony connection, an instant messaging connection or any combination of the above. Of course, the rich media advertisement can be any one of a number of electronic advertising systems capable of being displayed on the display 14 of the general purpose computer 12.

When the rich media advertisement is displayed, the sequential media asset, which may have been previously playing, is paused while the rich media advertisement is displayed. The rich media advertisement can be removed from the sequential media display area 38 by selecting a close button 58 located within the persistent banner advertisement 36 or by simply pressing the play button 42. An indicator (not shown) may be utilized by the media player 20 to encourage the user to close the rich media advertisement.

Another way for initiating the display of the rich media advertisement is to allow the media player 20 to finish playing the sequential media. When the sequential media is finished playing by the media player 20, the rich media advertisement can then be displayed within the sequential media area 38. It should be understood that the rich media advertisement shown after the sequential media asset has finished playing may be different from that shown previously.

As the user interacts with the rich media advertisement, information may be collected regarding the user's interactions. This can then be forwarded to the advertisement server 30. The information may then be used to create a profile indicating advertisements likely to pique the interest of the user, Once the profile has been created, the advertisement server 30 can then customize the rich media advertisement with the intention of providing a rich media advertisement likely to be of interest to the user.

The user's interaction with the rich media advertisement can include several factors. These factors may include time spent interacting with the rich media advertisement, behavior of the user when interacting with the rich media advertisement, performance metrics of the rich media advertisement, execution speed of the rich media advertisement, time and date when the user interacted with the rich media advertisement, the Internet Protocol address of the user, the user's system, platform, and web browser configuration information and the user's media identifier information.

Additionally, user information may be sent to a remote location such as the central server 26 (FIG. 1) such that the central server 26 can generate a profile based on the user information. After a profile is generated, the central server 26 can modify the advertising information contained within the media object based upon the profile. The user information collected by the central server may contain information regarding the user's interaction with the rich media advertisement. However, the user information may also contain information relating to a web page in which the sequential media is displayed.

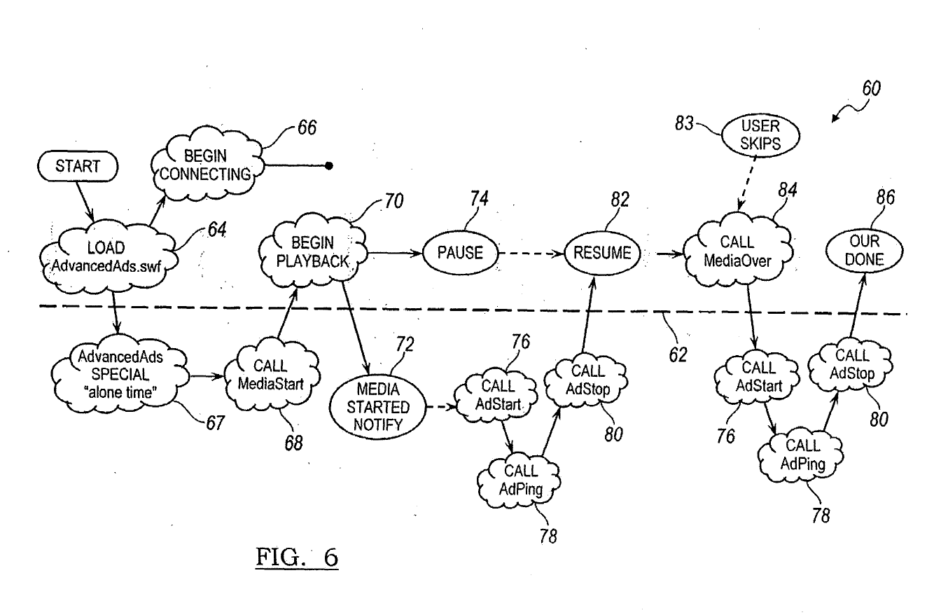

Referring to FIG. 6, a method 60 for configuring the media player to display advertising to the user of the general purpose computer 12 is shown. The method 60 is essentially divided into two parts by line 62. The steps located above line 62 are essentially the steps relating to the media player. The steps below line 62 are generally related to in the advertising asset that will control the media player so that the advertisements contained within the advertising asset can be displayed by the media player. As stated previously, in addition to containing advertising information, the advertising asset contains executable code for controlling the media player.

The method 60 begins with step 64, wherein the advertising asset is loaded. As stated previously, this is usually from a remote server. Thereafter, the media player begins connecting to the media asset, as shown in step 66. At about the same time, the advertising asset prevents the media asset from being displayed by the media player for a special “alone time”, as shown in step 67. During this “alone time”, the pre-roll advertisement of the advertising asset will be displayed by the media player. Essentially, the “alone time” is a set period of time wherein the advertising asset takes control of the media player and displays the pre-roll advertisement.

Once the “alone time” has expired and the pre-roll advertisement has finished playing, the advertising asset will instruct the media player to begin displaying the media asset, as shown in step 68, Once the media asset begins playback, as shown in step 70, the advertising asset is notified that the media asset has begun playing in step 72. Notifying the advertising asset that the media asset is playing can be useful. For example, assume that the media asset has not finished loading. The advertising asset can maintain control over what is shown by the media player until the media asset is ready for display. By so doing, the amount of time dedicated to advertising can be extended until the media asset is ready to be displayed.

As stated in the paragraphs previously, it was noted that the rich media advertisement can be displayed during the playback of the media asset after a first action (such as pausing the media player) has occurred. In this example, if the user presses a pause button of the media player, as shown in step 74, the advertising asset will then instruct the media player to begin showing the rich media advertisement, as shown in step 76.

While the rich media advertisement is being displayed by the media player, the advertising asset will determine if the rich media advertisement is properly playing by “pinging” the advertising media, as shown in step 78. If the rich media advertisement is not properly operating, the advertising asset will stop the displaying of the rich media advertisement (as shown in step 80) and resume the displaying of the media asset (as shown in step 82).

In step 82, when the rich media advertisement has ended or a second action has occurred (such as unpausing the media player), the rich media asset will continue playing. Once the rich media asset has finished playing or the user has skipped over viewing the rich media asset (as shown in step 83) the media player informs the advertising asset that the media asset has finished playing, as shown in step 84. Thereafter, the advertising asset executes steps 76, 78, and 80, which were described in the previous paragraphs, effectively displaying the rich media advertisement after the media asset has finished playing. Finally, the method finishes with step 86, wherein the media player indicates to the advertising asset that the sequence is finished.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

1. A method for configuring a media player to display advertising to a user of a computer via a display, the method comprising the steps of:
suspending the displaying of a media asset by the media player during an alone time;
displaying a pre roll advertisement in the display utilized by the media player during the alone time;
displaying the media asset after the alone time has expired;
suspending the displaying of the media asset when prompted by a first action;
displaying a first rich media advertisement in at least a portion of the display utilized by the media player when prompted by the first action;
resuming the displaying of the media asset when prompted by a second action; and
displaying a second rich media advertisement in at least a portion of the display utilized by the media player when the media player has finished displaying the media asset.

2. The method of claim 1, further comprising the steps of:
determining if the media asset is available;
displaying the pre roll advertisement in the display utilized by the media player until the media asset becomes available and after the alone time has expired.

3. The method of claim 1, wherein the first action is when the user selects a pause button or the media player or selects a persistent banner displayed by the media player.

4. The method of claim 1, wherein the second action is when the user selects a play button of the media player.

5. The method of claim 1, further comprising the steps of:
determining if the first or second rich media advertisement is operating properly;
resuming the displaying of the media asset when the first or second rich media advertisement is not operating properly.

6. The method of claim 1, further comprising the steps of:
determining if the displaying of the media asset has been terminated by the user;
displaying the first or second rich media advertisement in at least a portion of the display utilized by the media player when the media asset has been terminated by the user.

7. The method of claim 1, wherein the first and second rich media advertisements comprise the same rich media advertisement.

8. The method of claim 1, wherein the media asset is a video.

9. The method of claim 1, wherein the media asset comprise at least one of an interactive computer game, a static image, a micro website capable of launching other websites, an interactive map, an Internet telephony connection or an instant messaging connection.

10. The method of claim 1, wherein the first and second rich media advertisements comprise at least one of a video, an interactive computer game, a configurator for building, pricing and buying goods and/or services, a static advertisement, a micro website capable of launching other websites, an interactive map, an Internet telephony connection or an instant messaging connection.

11. A system for configuring a media player to display advertising to a user, the system comprising:
a computer having a processor and a memory unit containing instructions;
a display in communication with the processor of the computer for displaying a media asset via the media player;
a network interface in communication with the processor, the network interface configured to receive the media asset from a remote server via a network;
wherein the instructions configure the processor to:
suspend the displaying of a media asset by the media player during an alone time;
display a pre roll advertisement in the display utilized by the media player during the alone time;
display the media asset after the alone time has expired;
suspend the displaying of the media asset when prompted by a first action;
display a first rich media advertisement in at least a portion of the display utilized by the media player when prompted by the first action;
resume the displaying of the media asset when prompted by a second action; and
display a second rich media advertisement in at least a portion of the display utilized by the media player when the media player has finished displaying the media asset.

12. The system of claim 11, wherein the instructions further configure the processor to:
determine if the media asset is available;
display the pre roll advertisement in the display utilized by the media player until the media asset becomes available and after the alone time has expired.

13. The system of claim 11, wherein the first action is when the user selects a pause button or the media player or selects a persistent banner displayed by the media player.

14. The system of claim 11, wherein the second action is when the user selects a play button of the media player.

15. The system of claim 11, wherein the instructions further configure the processor to:
determine if the first or second rich media advertisement is operating properly;
resume the displaying of the media asset when the first or second rich media advertisement is not operating properly.

16. The system of claim 11, wherein the instructions further configure the processor to:
determine if the displaying of the media asset has been terminated by the user;
display the first or second rich media advertisement in at least a portion of the display utilized by the media player when the media asset has been terminated by the user.

17. The system of claim 11, wherein the first and second rich media advertisements comprise the same rich media advertisement.

18. The system of claim 11, wherein the media asset comprises a video.

19. The system of claim 11, wherein the media asset comprises at least one of an interactive computer game, a static image, a micro website capable of launching other websites, an interactive map, an Internet telephony connection or an instant messaging connection.

20. The system of claim 11, wherein the first and second rich media advertisements comprise at least one of a video, an interactive computer game, a configurator for building, pricing and buying goods and/or services, a static advertisement, a micro website capable of launching other websites, an interactive map, an Internet telephony connection or an instant messaging connection.
